(19) United States
(12) Patent Application Publication
(10) Pub. No.: US 2015/0161747 A1
(43) Pub. Date: Jun. 11, 2015

(54) System and Method for Guaranteed Energy Savings for the Customer

(71) Applicant: NRG ENERGY, INC., Houston, TX (US)

(72) Inventors: Kenneth Paul Keene, JR., The Woodlands, TX (US); Maria Gabriela Rodriguez, Houston, TX (US); Alicia Kathryn Lewis, Wayne, PA (US); Paul Todd Frantz, Voorhees, NJ (US); James Dale Steffes, Gladwyne, PA (US)

(73) Assignee: NRG ENERGY, INC., Houston, TX (US)

(21) Appl. No.: 14/286,522

(22) Filed: May 23, 2014

Related U.S. Application Data
(60) Provisional application No. 61/913,018, filed on Dec. 6, 2013.

(51) Int. Cl. G06Q 50/06

(52) U.S. Cl. CPC G06Q 50/06

(57) ABSTRACT

A method and system for providing a customer with guaranteed savings on its long-run energy charges as between a Utility and a Competitive Retailer. Preferably the method and system, including one or more computers with microprocessors for executing computer coded instructions, obtains and stores customer attributes, current energy provider, billing cycle and switching time constraints and restrictions and receives forecasted costs and prices of the Utility and the Competitive Retailer for the customer's next billing cycle. The system processes, via the computer, the customer data and the energy data for the Utility and Competitive Retailer to determine the energy provider projected to have the lower price for the next billing cycle of the customer. Preferably, the system requests a switch to the energy provider projected to have the lower price in that customer's next billing cycle, unless the customer is currently receiving service from the projected energy provider. In a preferred embodiment, the system obtains the actual prices of the Utility and the Competitive Retailer for the customer's billing cycle and charges the customer at the lower actual price.

### CROSS-REFERENCE TO RELATED APPLICATIONS

This application claims the benefit of U.S Provisional Application Ser. No. 61/913,018 filed Dec. 6, 2013 .

### BACKGROUND OF THE INVENTION

1. Field of the Invention

In one embodiment, the present invention relates generally to energy customers, more particularly to a system and method for providing guaranteed savings to energy customers for electric and/or natural gas supply charges.

2. Background of the Invention

In the late 1990s and early 2000s, many states enacted legislation deregulating portions of the natural gas and electricity value chains. The deregulation typically was phased in over a number of years. Prior to deregulation, the local utility (“Utility”) was in charge of procuring and delivering power to residences and businesses in its service territory. Under the deregulation legislation and accompanying regulations, the consumer could choose to continue purchasing power from the Utility or to purchase power from a competitive retail energy supplier (“Competitive Retailer”). Regardless of whether the customer chose to purchase electricity from the Utility or from a Competitive Retailer, the Utility would still be responsible for the delivery of the power.

In certain parts of the U.S., most customers still receive their electricity and natural gas from a Utility that procures and delivers their energy. In certain areas that are open to competition, customers may choose a Competitive Retailer to purchase their energy on the open market, while the Utility still delivers their energy and maintains the transmission and distribution infrastructure. Although in most deregulated jurisdictions, the Competitive Retailer may prepare and send a bill to the end-customer, most Competitive Retailers currently send charges for each invoice to the Utility instead of the end-customer, and the Utility processes the Competitive Retailer's charges and sends the end-customers one bill for all services.

In certain regions that are open to energy competition, Competitive Retailers compete against default supply rates (“Default Rates”) that are set by the Utility. The Default Rates are the rates charged by the Utility to the customer, and they are also referred to as the “Prices to Compare” or “PTCs”. Typically, Competitive Retailers do not guarantee customers long-term savings against Utility Default Rates since these Default Rates fluctuate over time, are published at different times by different Utilities, and are typically set to be “at cost”, with no margin added to the underlying cost of the commodity. Because Utilities typically procure inventory for their Default Rates in structured “laddered” supply agreements over time, during periods when wholesale energy costs are increasing, Default Rates can often be higher than the costs incurred by Competitive Retailers for competitive supply. However, the opposite often holds true during periods of stable or declining wholesale costs, as Default Rates fall below the supply costs incurred by Competitive Retailers. Since the Default Rates are complicated and difficult to beat in declining wholesale environments, Competitive Retailers tend to either offer discounts for short periods of time or offer fixed prices which can provide the customer price security that is not generally available with Default Rates.

The result is that there are numerous options and scenarios regarding pricing, usage, timing, and contract duration from which today's end-customer continues to choose from, which may or may not result in saving the customer money.

### SUMMARY OF THE INVENTION

A preferred embodiment of the present invention removes the price monitoring and decision-making burden from the customer and guarantees to the customer that its long-run energy charges will represent the lowest amount as if the customer had enrolled with either the Utility or Competitive Retailer, whichever entity charged the lower amount in a given billing cycle, for a longer term than any other offer in the market.

In the preferred embodiment, the customer authorizes a third party or a Competitive Retailer to be the customer's representative for utility and supplier transactions. The system and method includes one or more computers with microprocessors for executing computer coded instructions. The preferred embodiment obtains and stores customer attributes, current energy provider, billing cycle and switching time constraints and restrictions and receives forecasted costs and prices of the Utility and the Competitive Retailer for the customer's next billing cycle. The system processes, via the computer, the customer data and the energy data for the Utility and Competitive Retailer to determine the energy provider projected to have the lower price for the next billing cycle of the customer. Preferably, the system requests a switch to the energy provider projected to have the lower price in that customer's next billing cycle, unless the customer is currently receiving service from the projected energy provider. In a preferred embodiment, the system obtains the actual prices of the utility and the Competitive Retailer for the customer's billing cycle and charges the customer at the lower actual price.

### BRIEF DESCRIPTION OF THE SEVERAL VIEWS OF THE DRAWINGS

So that the manner in which the recited features, advantages and aspects of the embodiments of the present invention are attained and can be understood in detail, a more particular description of the invention may be had by reference to the preferred embodiments thereof which are illustrated in the appended drawings, which drawings are incorporated as a part hereof.

It is to be noted however, that the appended drawings illustrate only typical embodiments of this invention and are therefore not to be considered limiting of its scope, for the invention may admit to other equally effective embodiments.

FIG. 1 is an illustration of a system that guarantees savings to the customer between a Utility and a Competitive Retailer according to a preferred embodiment of the invention;

FIG. 2 is an illustration regarding customer enrollment according to a preferred embodiment of the invention;

FIG. 3 is an illustration of the system logic to guarantee savings to the customer according to a preferred embodiment of the invention;

FIG. 4 is a flow chart of a preferred process of the guaranteed savings system and billing to the customer;

FIG. 5 is a flow chart of an alternative process of the guaranteed savings system and billing to the customer in the event of certain market restrictions or product/service/System variations; and

FIG. 6 is a flow chart of an alternative process of the guaranteed savings system and billing to the customer in the event of certain market restrictions.

### DESCRIPTION OF THE PREFERRED EMBODIMENTS

When every customer has the benefit of choosing either a Competitive Retailer or default service under the Utility, one of the principal criteria for the choice is the price of the service and underlying commodity. Although non-price factors still enter into customers' choices, price tends to be one of the principal factors.

Trying to evaluate and assess the best choice for a customer can be complicated, time-consuming, and uncertain for the customer. While one Competitive Retailer may have the lowest price at the current time, it may not have the lowest price at some later point during the term of the customer's contract with the Competitive Retailer. This requires the customer to monitor the market for competitive prices, monitor Default Rate changes, and be aware of deadlines for switching service providers for each billing cycle if they desire to optimize the price of their energy. The present invention removes the price monitoring and decision-making burden from the customer and guarantees to the customer that its long-run energy charges will represent the lowest amount as if the customer had enrolled with either the Utility or Competitive Retailer, whichever entity charged the lower amount in a given billing cycle, for a longer term than any other offer in the market. It is to be understood that the system could be housed at or receive energy data from a third-party or, in an alternative embodiment the system could receive energy data directly from a Competitive Retailer or from a plurality of Competitive Retailers and the customer could be guaranteed that its long-run energy charges would represent that same amount as if the customer had enrolled with whichever supply entity that charged the lowest amount in a given billing cycle.

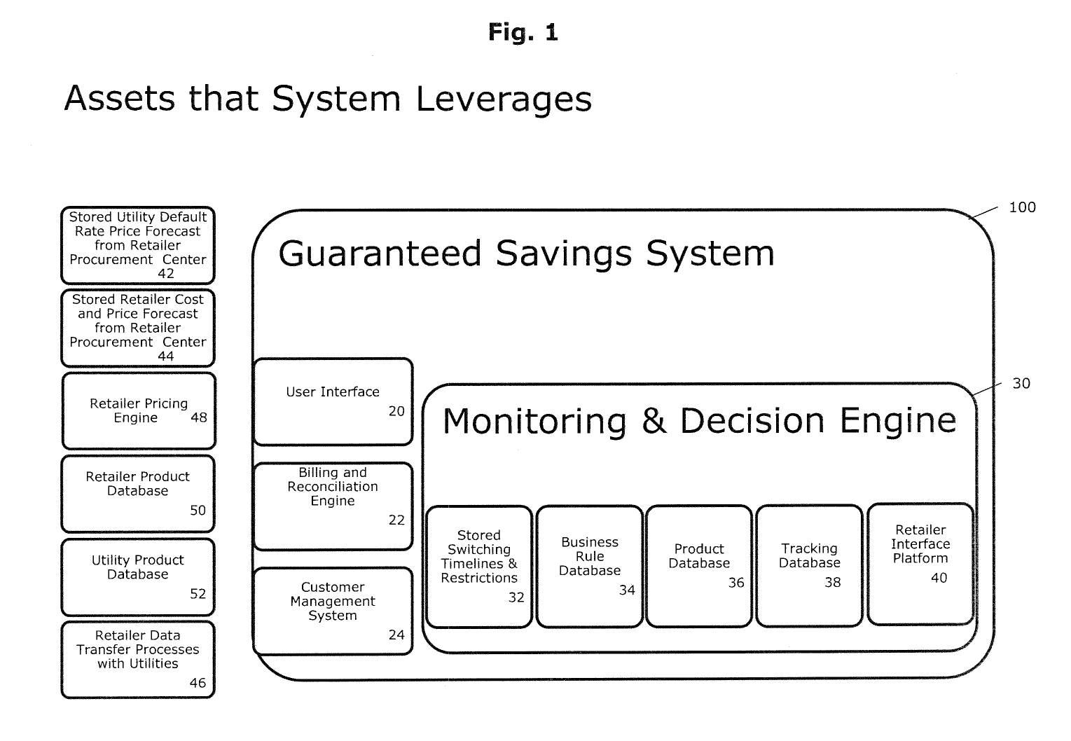

A preferred embodiment of the present invention is described below in conjunction with the appended drawings. FIG. 1 is an illustration of an embodiment of a system that guarantees savings to the customer between a Utility and a Competitive Retailer. The system preferably includes one or more computers having microprocessors for executing computer coded instructions as explained below. Referring to FIG. 1, the components of the Guaranteed Savings System 100 are made up primarily of a User Interface 20, a Billing and Reconciliation Engine 22, a Customer Management System 24, and a Monitoring and Decision Engine 30. The customer-facing User Interface 20 is used for enrollment and potentially ongoing account monitoring. The Billing and Reconciliation Engine 22 supports customer billing processes and pricing adjustments needed to guarantee savings to the customer between the Utility and the Competitive Retailer. The Customer Management System 24 stores customer data and provides the ability for representatives to access and change customer data and account attributes as needed. The Monitoring and Decision Engine 30 houses the switching timelines and switching restrictions 32 between Utilities and Competitive Retailers by market as well as the Business Rules Database 34 for switching decisions. The Business Rules Database 34 feeds into a Retailer Interface Platform 40 that interacts with the Competitive Retailer systems. All actions of the System 100 are tracked in the Tracking Database 38. The Product Database 36 houses the available products that the System 100 offers to customers and interacts with the Billing and Reconciliation Engine 22 to charge customers for the products.

The System 100 uses certain assets already available to Competitive Retailers such as stored Default Rate forecasts for Utilities 42 and stored Cost and Price Forecasts for Competitive Retailers 44. These Cost and Price Forecasts are typically managed by the Procurement Center of the Competitive Retailer, which is responsible for the wholesale markets. Procurement Centers of Competitive Retailers typically hire vendors that house historical industry data and provide sophisticated and dynamic modeling software tools that use market data for electric demand, generation, fuel costs, transmission constraints, and other key assumptions to forecast wholesale costs and measure the impact of potential market changes. In addition, the System 100 leverages Data Transfer Processes 46 already in place between Utilities and Competitive Retailers for switch requests as well as the Competitive Retailer's Pricing Engine 48 for price decreases at the Competitive Retailer. The System 100 also leverages Product Databases for Competitive Retailers and Utilities, 50 and 52 respectively, which are stored at the Competitive Retailer and which include stored data for the actual historical pricing and currently available offers from both entities so the System 100 can decide on a course of action for a customer based on the particular products offered by either entity.

In the preferred embodiment of the present invention, the customer is required to authorize the system service provider, preferably the Competitive Retailer or a third-party entity, to be the customer's ongoing advocate with respect to selecting the energy provider for the customer and collecting and/or administering the customer's energy bills. For example, the authorization may be effectuated by a Power of Attorney or other letter of authorization from the customer to the service provider. The required form of authorization may vary from state to state or by Utility. For purposes of describing the invention below, the service provider is a Competitive Retailer.

It is to be understood that the Competitive Retailer may produce its own energy or purchase the energy from energy producing companies in the marketplace. In either instance, the Competitive Retailer has to continuously monitor several variables—all or some of which have an impact on its cost of the energy and prices. For example, variables can include time of year, fluctuating costs to produce energy, length of contract with fixed pricing or conditions, and energy demands (projected or real), to name a few. Often, Competitive Retailers and Utilities forecast future volume as well as future wholesale costs to determine hedging, price, and price change strategies. Forecasts for Competitive Retailer and Utility pricing are derived from this information and adjusted as expected volumes and costs change, as real-time volumes and costs change, and as Default Rates are published and implemented by Utilities. Often, the Competitive Retailer processes, analyzes and calculates the lowest price at which it can sell the energy while still making a profit. This lowest price is referred to as the minimum or set pricing threshold and is a price at which the Competitive Retailer does not want to go below. The minimum pricing threshold (MPT) for the Competitive Retailer would be determined based on the account attributes and billing cycle for an individual.

In the preferred embodiment, a System enterprise application electronically receives energy data from an energy provider, typically the Utility, and energy data from another energy provider, typically the Competitive Retailer. The System 100 electronically receives customer data related to the energy consumption by the customer, typically from the Utility. The System 100 processes the energy data for both providers and customer data, preferably in real-time, to determine a preferred energy provider selected from a group of providers comprised of at least two. It is to be understood that in an alternative embodiment the System 100 could receive energy data from a plurality of Competitive Retailers.

In one embodiment, the energy data provided to the System 100 includes energy price information that can vary constantly. The System 100 is programmed to recognize switching deadlines in relation to customer billing cycles, Default Rate change and allocation rules, and analyze the customer's individual account attributes (e.g. rate class, usage patterns, zone) and the forecasted costs and prices based on those individual account attributes to determine which energy provider provides the energy for the lowest price to the customer.

In one embodiment, the Competitive Retailer or the System determines a Minimum Pricing Threshold at which the Competitive Retailer does not want to go below when providing its produced or purchased energy to the customer. For example, the Minimum Pricing Threshold of the Competitive Retailer may currently be 8.5 cents per kilowatt-hour, and given wholesale costs, anything under 8.5 cents per kilowatt-hour would be unprofitable for the Competitive Retailer. In this example, if the Default Rate of the Utility was 10 cents per kilowatt-hour, the System directs that the energy to the customer be provided by the Competitive Retailer, and takes any actions required to switch service provision to the Competitive Retailer. Depending on various factors, the price charged to the customer will be at or above 8.5 cents per kilowatt-hour but below 10 cents per kilowatt-hour. This is only one embodiment of the offer as situations with headroom between the Competitive Retailer's Minimum Pricing Threshold and the Utility Default Rate could lead to a number of offer variations for the customer such as percentage savings below the Utility Default Rate or a “shared savings” model with customers or products with more dynamic pricing based on the time of energy use or usage levels. This ensures that the customer saves money by being with the Competitive Retailer as opposed to being with the Utility.

In a second example, the Minimum Pricing Threshold of the Competitive Retailer may currently be 10 cents per kilowatt-hour and the Utility Default Rate may be 8.5 cents per kilowatt-hour. In this situation, the System directs that the customer's energy should be provided by the Utility. The price charged to the customer will be 8.5 cents per kilowatt-hour as opposed to 10 cents per kilowatt-hour. This ensures that the customer saves money by being charged at the Utility Default Rate as opposed to the Competitive Retailer's supply price. This may be accomplished by having the System switch the customer to the Utility for service or by the retail energy supplier overriding its Minimum Pricing Threshold to match the Utility Default Rate while service continues with the Competitive Retailer. Thus, the System and method of the present invention provides energy to the customer at the lower of the available prices of the Utility and the Competitive Retailer—providing guaranteed savings to the customer when compared to being with just one of the Utility or Competitive Retailer over the entire period of time.

In a preferred embodiment, the Competitive Retailer, a third-party, or the System 100 triggers a request to transfer the customer's energy provider from the present source to the new source which has been determined to provide price savings to the customer. Various factors may contribute to switching energy providers. For example, a change of Default Rate(s) by the Utility, a change of price(s) by the Competitive Retailer, a change in the customer's individual account attributes, to name a few.

The preferred embodiment of the System 100 will monitor and analyze for a customer competing prices of the Competitive Retailer against the Utility at all times. The System 100 will automatically monitor, signal or request to switch the customer's service to the Competitive Retailer or the Utility to achieve the lowest price between the options. The customer receives clear value and pricing advantage. Savings for the customer will be guaranteed for each month of service without the need for annual refunds. In an alternative embodiment, the System 100 could be expanded to include switches to multiple energy suppliers or other forms of energy.

In one embodiment, the System and service would include a monthly service charge and provide the customer with a guarantee that the customer will be charged at the lowest energy price offered by the Utility and the Competitive Retailer even though the switching to the Utility or Competitive Retailer is delayed several days or for longer than one billing cycle. It is common that time delays for switching to or from a Utility may take days and even weeks. Thus, when the System 100 triggers or requests a switch of energy supplier and the transfer to the desired energy supplier takes, for example, 3 weeks before the switch is completed, in one embodiment the System will monitor the customer's energy usage during this switching time interval and ensure that the customer ends up paying for this used energy at the lower price as if the switch had occurred without delay.

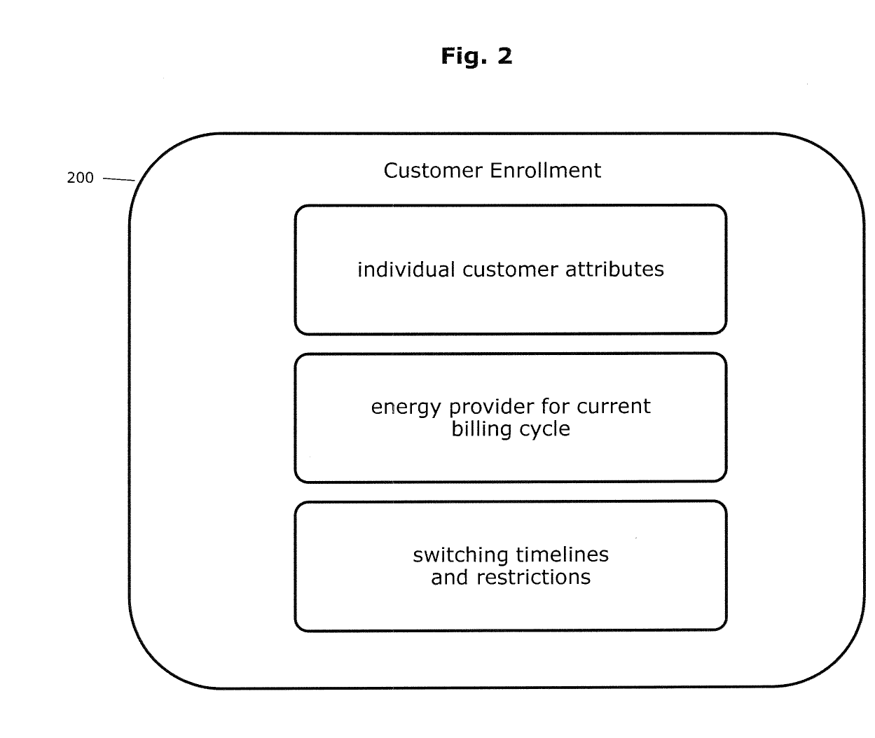

The following is an explanation of the System methodology beginning at customer enrollment 200 as shown in FIG. 2. Preferably, the customer enrolls through the System's User Interface 20 (FIG. 1) and the System 100 captures all the customer's individual billing attributes that are relevant for service. The System 100 also recognizes which entity is providing service for the customer's current billing cycle so that the stored switching timelines and switching restrictions 32 applicable to the market can be applied. The System 100 also stores all customer data in the Customer Management System 24 at this time and on an ongoing basis.

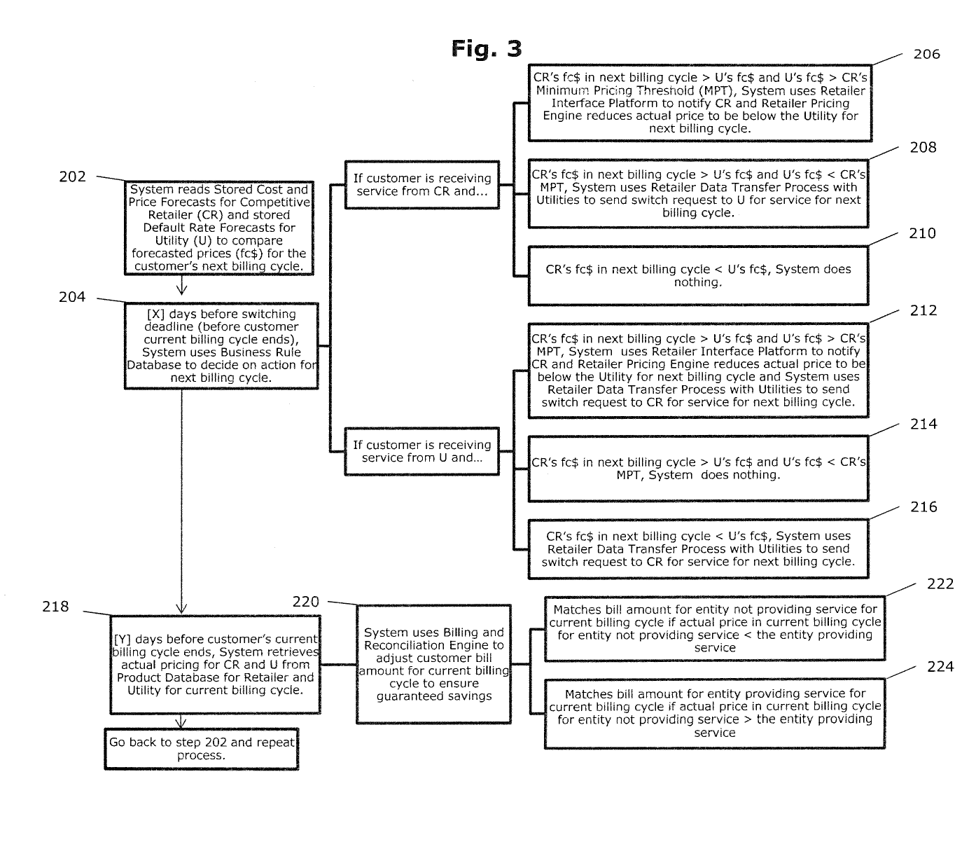

With reference to FIG. 3, the System 100, according to a preferred embodiment of the invention, at block 202 reads data from the stored cost and price forecasts for the Competitive Retailer and the Utility for the individual customer so that the System 100 can compare forecasted prices for the customer's next billing cycle between entities. In some embodiments, block 202 may be performed on a daily basis.

Referring to block 204, at a point in time that is prior to the switching deadline for a customer's account ([X]), which varies by Utility, the System's Business Rule Database 34 dictates a course of action for the customer's account for the next billing cycle based on the forecasted costs and prices for the Competitive Retailer and the Utility and the ability of the Competitive Retailer to beat the Utility's Default Rate by comparing the Competitive Retailer's forecasted price and Minimum Pricing Threshold to the forecasted Utility's Default Rate for the next billing cycle.

In the illustrated embodiment shown in FIG. 3, if the Competitive Retailer's forecasted price for the next billing cycle is above the forecasted Utility's Default Rate, but the Competitive Retailer's price can be lowered to beat the Utility's Default Rate without going below the Competitive Retailer's Minimum Pricing Threshold (MPT), the System 100 will signal to the Competitive Retailer that it should lower its forecasted price to this level and the System will ensure that the customer receives service with the Competitive Retailer for the next billing cycle, either by sending a switch request to the Competitive Retailer through the Competitive Retailer's existing Data Transfer processes with the Utility (block 212), or by doing nothing (block 206) if service is already being provided by the Competitive Retailer.

If the Competitive Retailer's forecasted price is above the forecasted Utility's Default Rate and the Competitive Retailer's price cannot be lowered to beat the Utility's Default Rate without going below the Competitive Retailer's Minimum Pricing Threshold, the System 100 will ensure that the customer receives service with the Utility for the next cycle, either by sending a switch request to the Utility through the Competitive Retailer's existing Data Transfer processes with Utilities 46 (block 208), or by doing nothing (block 214) if service is already being provide by the Utility.

Similarly, if the forecasted Utility's Default Rate 42 is above the Competitive Retailer's forecasted price 44, the System 100 will ensure that the customer receives service with the Competitive Retailer for the next cycle, either by sending a switch request to the Competitive Retailer through the Competitive Retailer's existing Data Transfer processes with Utilities 46 (block 216), or by doing nothing (block 210) if service is already being provided by the Competitive Retailer.

At some point prior to the end of a customer's billing cycle ([Y]) when actual pricing is available for the Competitive Retailer and the Utility, which varies by Utility, the System 100 retrieves the actual Competitive Retailer price and the actual Utility Default Rate for the customer's current billing cycle from the Product Databases for the Competitive Retailer and the Utility, 50 and 52 respectively, in block 218. The System 100 in block 220 uses the Billing and Reconciliation Engine 22 to reconcile between forecasted prices and actual prices to adjust the customer bill amount for the current billing cycle to ensure guaranteed savings for that billing cycle. The customer is billed at the lower price of the actual prices of the Competitive Retailer and Utility for that billing cycle, regardless of which entity provided the energy as indicated in blocks 222 and 224. The process of FIG. 3 is repeated for each billing cycle.

The following example illustrate how the above-described System 100 shown in FIGS. 2 and 3 works. John enrolls on July 1. The System captures that John is a residential customer in

Pennsylvania with a 31 day billing cycle that is currently with Retailer. John's default service is with Utility and any switches must be requested ten (10) days before the end of John's billing cycle in order for the changes to take effect for the next billing cycle. On July 21, ten (10) days before the end of John's billing cycle, the System reads the forecasted prices for John at Utility and Retailer for John's August bill. The forecasted prices on July 21 is 10 cents per kilowatt-hour with Utility and 11 cents per kilowatt-hour with Retailer, however, the minimum threshold price for Retailer is 8 cents per kilowatt-hour. The System notifies Retailer and Retailer reduces the actual price to 8 cents per kilowatt-hour for John's August bill. John's energy provider continues to be Retailer during August.

On August 1, thirty (+) days before the end of John's current billing cycle, the System reads the actual price for John at Utility and Retailer for John's August bill. The actual price for John's August bill is 7 cents per kilowatt-hour with Utility and 8 cents per kilowatt-hour with Retailer. The System bills John for 7 cents per kilowatt-hour in August.

On August 21, ten (10) days before the end of John's billing cycle, the System reads the forecasted price for John at Utility and at Retailer for John's September bill. The forecasted price for John's September bill is 7 cents per kilowatt-hour with Utility and 8 cents per kilowatt-hour with Retailer and the minimum threshold price for Retailer is 8 cents per kilowatt-hour. The System requests that John switches to receive service from Utility in September.

On September 1, thirty (30) days before the end of John's current billing cycle, the System reads the actual price for John at Utility and at Retailer for John's September bill. The actual price for John's September bill is 7 cents per kilowatt-hour with Utility and 8 cents per kilowatt-hour with Retailer. The System bills John for 7 cents per kilowatt-hour in September.

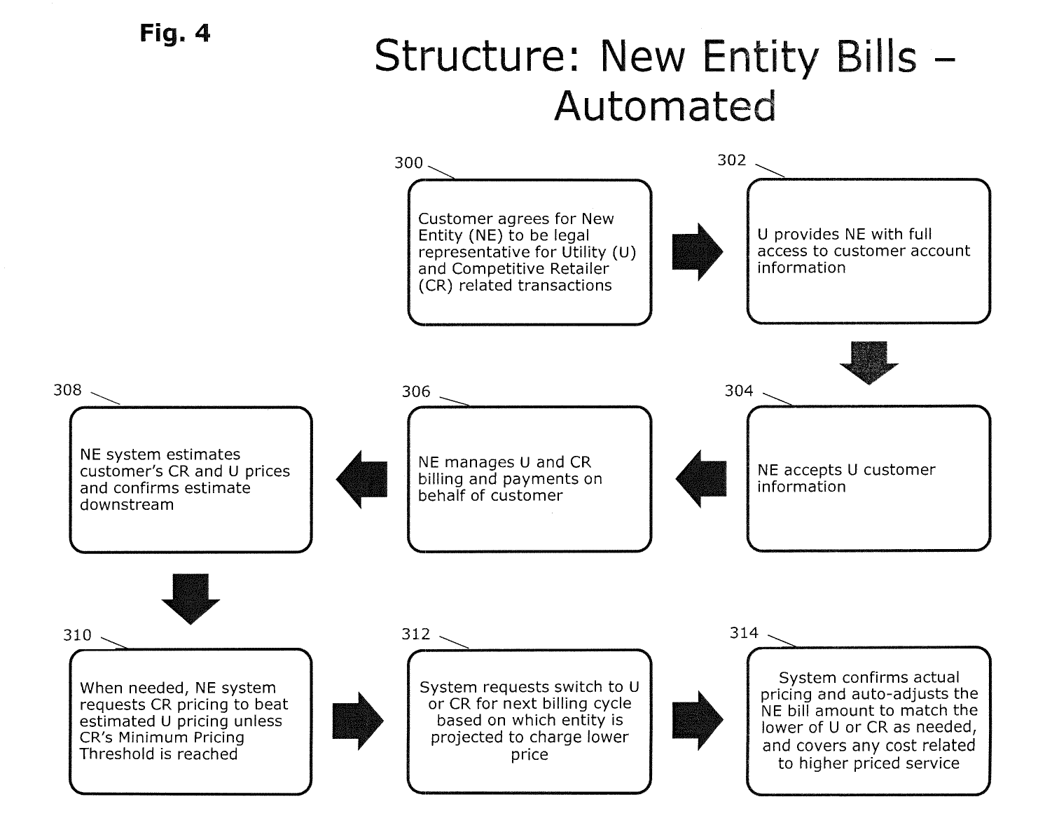

FIGS. 4, 5 and 6 are flow diagrams of alternative processes of the Guaranteed Savings System 100 and billing to the customer in the event of certain market restrictions or product/service/System variations.

In a preferred embodiment, the Competitive Retailer or a third-party entity would manage all energy bills (e.g., electricity, natural gas) on behalf of the customer (Utility provides access to or sends to Competitive Retailer or a third-party entity (“New Entity”); and Competitive Retailer or New Entity sends invoice to customer seamlessly and reconciles with Utility). A flow diagram of a New Entity monitoring, switching, and providing automated billing services is shown in FIG. 4. The New Entity (“NE ”) is preferably a third-party entity formed to provide these services that may charge a monthly fee for the monitoring, switching, and billing services. The customer agrees for New Entity to be the legal representative for Utility and Competitive Retailer related transactions (block 300). The Utility provides New Entity with full access to customer account information as desired by customer (block 302) and New Entity obtains customer information (e.g. electronic statements, account screen scrapes, etc.) from the Utility (block 304). At block 306, the New Entity manages Utility and Competitive Retailer billing and payments on behalf of the customer. New Entity's system estimates the Competitive Retailer's and Utility's prices for the customer given margin of error and confirms the estimates downstream (block 308). When needed, New Entity's system requests the Competitive Retailer to beat the Utility pricing. The Competitive Retailer will beat the estimated Utility pricing unless the Competitive Retailer's Minimum Pricing Threshold is reached (block 310). Based on which entity is projected to charge the lower price for the next billing cycle, the System requests switch to that entity for next billing cycle if not currently receiving energy from that entity (block 312). The System confirms the actual pricing of the Utility and Competitive Retailer for the billing cycle and automatically adjusts the customer's New Entity bill amount to match the lower actual price of the Utility or Competitive Retailer as needed, and the New Entity covers any cost related to the customer having received energy from the higher priced service (block 314).

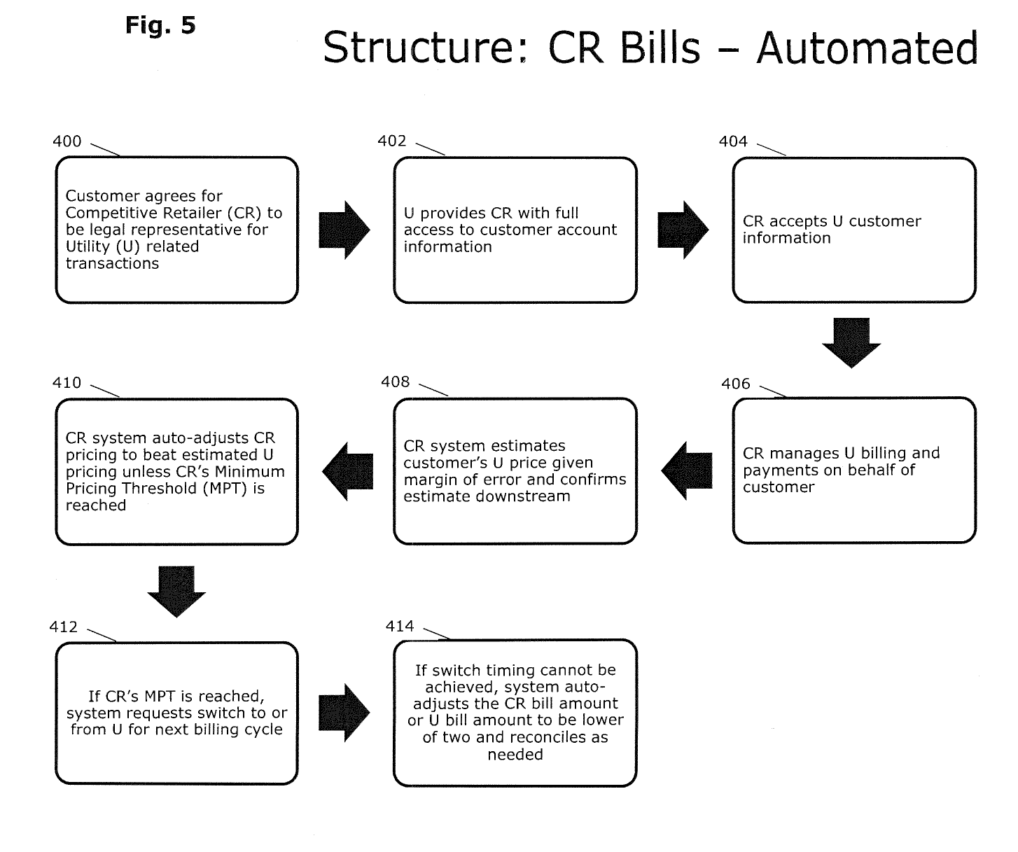

FIG. 5 is a flow chart similar to FIG. 4, but with the Competitive Retailer also providing the services that the New Entity provides in FIG. 4. The Competitive Retailer may charge a monthly fee for monitoring and switching service. The customer agrees for Competitive Retailer to be the legal representative for Utility related transactions (block 400). The Utility provides Competitive Retailer with full access to customer account information as desired by customer (block 402) and Competitive Retailer obtains customer information (e.g. electronic statements, account screen scrapes, etc.) from the Utility (block 404). At block 406, the Competitive Retailer manages Utility billing and payments on behalf of the customer. Competitive Retailer's system estimates Utility's Default Rate for the customer given margin of error and confirms the estimate downstream (block 408). Competitive Retailer's system automatically adjusts the Competitive Retailer's pricing to beat the estimated Utility Default Rate unless the Competitive Retailer's Minimum Pricing Threshold is reached (block 410). If the Minimum Pricing Threshold is reached, the system requests a switch to or from Utility for the next billing cycle (block 412). If the switch timing cannot be achieved, the System automatically adjusts the Competitive Retailer's or Utility's bill amount for the customer to be the lower price of the two and the Competitive Retailer reconciles as needed (block 414).

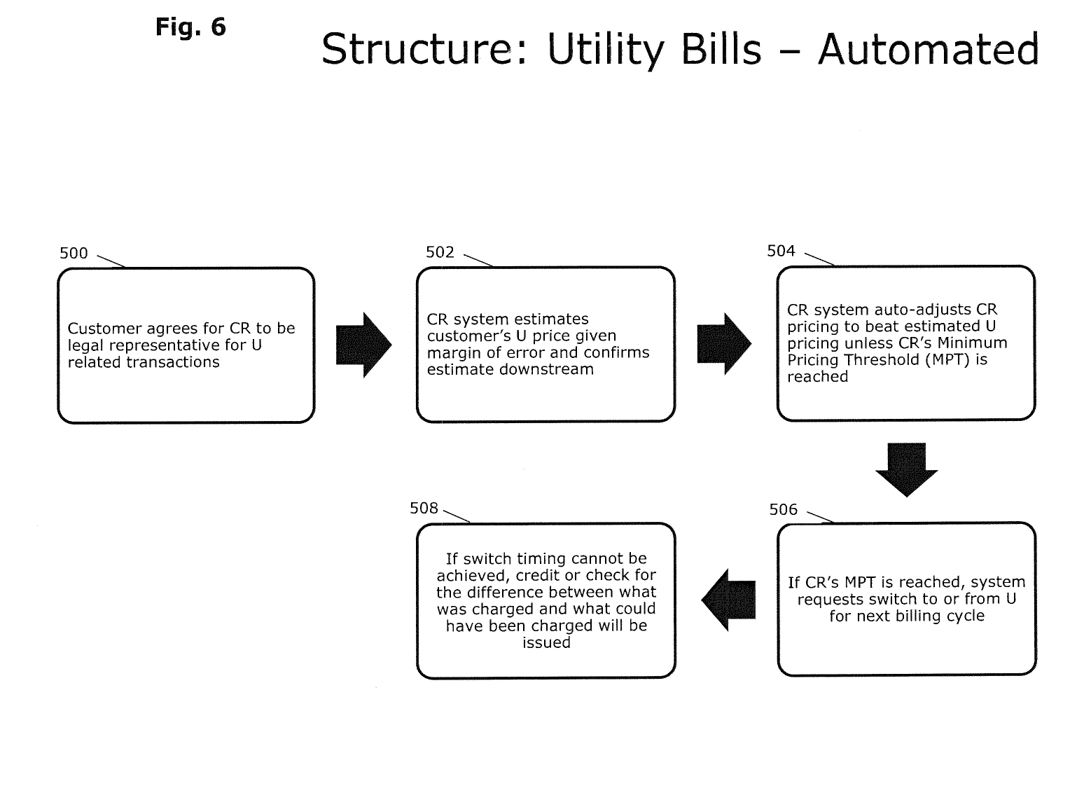

FIG. 6 is another alternative process in which the Utility invoices the customer. The customer agrees for Competitive Retailer to be the legal representative for Utility related transactions (block 500). Competitive Retailer's system estimates Utility's Default Rate for the customer given margin of error and confirms the estimate downstream (block 502). Competitive Retailer's system automatically adjusts the Competitive Retailer's pricing to beat the estimated Utility Default Rate unless the Competitive Retailer's Minimum Pricing Threshold is reached (block 504). If the Minimum Pricing Threshold is reached, the system requests a switch to or from Utility for the next billing cycle (block 506). If the switch timing cannot be achieved, the System generates a credit or a check issued to the customer for the difference between what was charged and what could have been charged (block 508).

In a preferred embodiment, the Competitive Retailer or third-party invoices will reflect any applicable Utility charges. The Guaranteed Savings System includes algorithms that anticipate or estimate Utility Default Rates by customer. Each month, the System automatically converts the estimated data to Utility charges per customer invoice with a reconciliation against real Utility charges and sends signals to automatically adjust Competitive Retailer pricing to beat the Utility unless the Competitive Retailer's Minimum Pricing Threshold is reached. If the Competitive Retailer's Minimum Pricing Threshold is reached, the System automatically keeps the customer at the Utility or sends a signal to the Utility to request a switch to the Utility from the Competitive Retailer on behalf of the customer for the next invoice or billing period. If the Utility cannot accept a switch in time for the customer's next invoice, the System overrides charges of either party as needed to ensure that the billed amount to the customer is the lower of the two parties. Depending on whether the customer is with the Utility or the Competitive Retailer at the time of a desired switch that cannot occur in time, the System either overrides the Competitive Retailer's Minimum Pricing Threshold and charges the customer at the Utility's Default Rate to ensure savings to the customer or overrides the Utility Default Rates to be the price that could have been charged by the Competitive Retailer.

Each billing cycle, the System continues to compare future Utility Default Rates against the Competitive Retailer's Minimum Pricing Threshold. If the customer is with the Utility and the Competitive Retailer cannot go below the Utility Default Rate, no action is taken and the customer stays with the Utility. Similarly, if the customer is with the Competitive Retailer and the Utility Default Rates do not go below the Competitive Retailer's pricing, no action is taken and the customer stays with the Competitive Retailer.

In the preferred embodiment of the present invention, the individual customer's usage profile is a factor in determining the forecasted rates for the customer of the Utility and the Competitive Retailer. Additionally, Competitive Retailers tend to have many more product offerings or structures to apply to a customer than a Utility does. It is to be understood that the various product offerings of the Competitive Retailer and the Utility are also factors in determining the forecasted rates.

It is to be understood that variations may occur with billing structures, with means of obtaining authorization for customer legal representation, with data transfer between Utilities, Competitive Retailers, or third-party entities, with event timelines to accommodate cancellation, re-enrollment, and Utility Default Rate change timelines by market.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for providing a customer with guaranteed savings of energy charges as between a utility and a competitive retailer, the method comprising the steps of:
providing at least one computer having a microprocessor for executing computer coded instructions;
obtaining and storing customer attributes. current energy provider. billing cycle and switching time constraints and restrictions;
receiving forecasted costs and prices of the utility and the competitive retailer for the customer's next billing cycle;
processing, via the computer, the forecasted prices and next billing cycle for customer to determine which energy provider is projected to have the lower price for the customer in the customer's next billing cycle;
requesting a switch to the energy provider with the projected lower price in that customer's next billing cycle, unless the customer is currently receiving service from that energy provider;
obtaining the actual prices of the utility and the competitive retailer for the customer's billing cycle; and
charging the customer at the lower actual price.

2. The method of claim 1, further comprising the step of receiving a minimum pricing threshold of the competitive retailer, wherein if the utility forecasted price is less than the competitive retailer forecasted price but the competitive retailer minimum pricing threshold is less than the utility forecasted price, the projected energy provider for the next billing cycle is the competitive retailer.

3. The method of claim 1, further comprising the step of obtaining authorization from the customer to be customer's representative for utility and supplier transactions.

4. The method of claim 1, wherein the step of requesting a switch is timed to avoid lengthy delays in switching of service.

5. A method for providing a customer with guaranteed savings of energy charges as between a utility and a competitive retailer, the method comprising the steps of:
obtaining authorization from the customer to be customer's representative for utility and supplier transactions;
providing at least one computer having a microprocessor for executing computer coded instructions;
obtaining and storing customer attributes, current energy provider, billing cycle and switching time constraints and restrictions;
receiving forecasted costs and prices of the utility and the competitive retailer for the customer's next billing cycle;
processing, via the computer,the forecasted prices and next billing cycle for customer to determine which energy provider is projected to have the lower price for the customer in the customer's next billing cycle;
requesting a switch to the energy provider with the projected lower price in that customer's next billing cycle, unless the customer is currently receiving service from that energy provider;
obtaining the actual prices of the utility and the competitive retailer for the customer's billing cycle; and
charging the customer at the lower actual price.

6. The method of claim 5, wherein the step of requesting a switch is timed to avoid lengthy delays in switching of service.

7. The method of claim 5, further comprising the step of receiving a minimum pricing threshold of the competitive retailer, wherein if the utility forecasted price is less than the competitive retailer forecasted price but the competitive retailer minimum pricing threshold is less than the utility forecasted price, the projected energy provider for the next billing cycle is the competitive retailer.

8. The method of claim 7, wherein the step of requesting a switch is timed to avoid lengthy delays in switching of service.

9. A data processing system for managing energy-related data for individual customers and a Utility and at least one Competitive Retailer, and generating outputs to the customers detailing energy consumption and pricing while providing the customers with guaranteed savings of energy charges as between the Utility and the at least one Competitive Retailer, the data processing system comprising:
at least one computer having a microprocessor for computing data input to said computer;
at least one management application including at least one of a software or firmware installation that provides computer coded instructions to the at least one computer for managing data manipulated by the at least one computer;
at least one database communicating with the at least one computer for storing data regarding Utility default rate forecasts, Competitive Retailer cost and price forecasts, and the current energy provider, billing cycle and historical energy consumption data for the individual customers;
wherein the microprocessor is configured to calculate a customer's energy bill based upon the customer's energy consumption and the lowest actual price available from the Utility and Competitive Retailer for the customer during the customer's billing cycle.

10. The data processing system of claim 9, wherein the at least one database further stores switching timelines and restrictions between the Utility and the at least one Competitive Retailer and business rules relating to making switching decisions.
